(19) United States
(12) Patent Application Publication
(10) Pub. No.: US 2014/0048387 A1
(43) Pub. Date: Feb. 20, 2014

(54) MULTI STREAM MATERIAL PROCESSING APPARATUS

(71) Applicant: Wyssmont Company Inc., Fort Lee, NJ (US)

(72) Inventor: Edward Weisselberg, Kinnelon, NJ (US)

(73) Assignee: WYSSMONT COMPANY INC., Fort Lee, NJ (US)

(21) Appl. No.: 14/061,217

(22) Filed: Oct. 23, 2013

Related U.S. Application Data
(62) Division of application No. 13/183,671, filed on Jul. 15, 2011.

(51) Int. Cl. B65G 37/00

(52) U.S. Cl. CPC B65G 37/00
USPC 198/542

(57) ABSTRACT

A method and apparatus for processing material cascading through a treatment chamber uses a plurality of vertically stacked shelves divided into trays by spaced apart openings. As the shelves rotate, material contained with each tray is discharged through one of the openings to one or more trays of an underlying shelf. The material to be processed is supplied to the uppermost shelf through one or more material inlets, and discharged from the lowermost shelf through one or more material outlets. The material that enters each feed opening stays substantially together as it spirals down through the chamber. The multiple trays provide for shorter retention time of material within each tray which is adaptable for processing heat sensitive materials along separate material flow paths within the treatment chamber.

### CROSS REFERENCE TO RELATED APPLICATIONS

The present application is a divisional of U.S. patent application Ser. No. 13/183,671, filed Jul. 15, 2011, which is expressly incorporated herein by reference in its entirety.

### BACKGROUND OF THE INVENTION

The present invention relates in general to an apparatus and methods for the continuous treatment of various materials, and in particular, concurrently in multiple processing zones.

Industrial dryers and chemical reactors are used for processing a wide range of materials, such as dyes, bleach, sugar, flame retardants, carbon, fungicides, vitamins, wood chips, pharmaceuticals, coffee, and the like. The processing equipment may include large drying or processing chambers where the materials are exposed to treatment conditions for a period of time. Treatment conditions may include incorporating heat and cold, positive and negative pressures, desiccants, inert atmospheres, reactive gases for the continuous treatment of the materials and the like. One exemplary apparatus known as the TURBO-DRYER® thermal processor is manufactured by Wyssmont Company Inc. of Fort Lee, N.J. which provides a processing chamber having a plurality of trays stacked in a vertical orientation forming a plurality of processing zones. The trays may be rotated about a central axis extending through the processing chamber by connection to a drive source. The material being processed cascades downwardly to each tray in the stack as the trays rotate, and an optional source of an artificial environment can be supplied through a duct or manifold connected to the processing chamber. Internally located fans circulate the internal environment evenly in contact with the cascading material between processing zones. As a result, the material is thoroughly and evenly processed within the apparatus.

Examples of specific applications for the TURBO-DRYER® include torrefaction of cellulose based material as disclosed in U.S. patent application Ser. No. 12/456,427 filed on Jun. 15, 2009 entitled “System And Method For Drying And Torrefaction”; extraction of hydrocarbons from oil shale containing kerogen as disclosed in U.S. patent application Ser. No. 12/589,394 filed on Oct. 22, 2009 entitled “Method For The Pyrolytic Extraction Of Hydrocarbon From Oil Shale”; and continuous freeze drying of a material by sublimation under substantially atmospheric pressure as disclosed in U.S. patent application Ser. No. 12/950,336 filed on Nov. 19, 2010 entitled “Apparatus And Method For Continuous Lyophilization,” the disclosures of which are incorporated herein by reference.

The present invention relates in general to improvements in a material processing apparatus having contiguous processing zones suitable for treating materials under varied processing conditions and methods of processing various materials therein.

### SUMMARY OF THE INVENTION

The present invention in accordance with one embodiment discloses a material processing apparatus and methods for processing materials therein. The apparatus is constructed for processing a plurality of separate material streams passing downwardly throughout the apparatus in a spiral fashion. The material streams remain separate from one another within the apparatus, although some commingling is contemplated. Each material stream is associated with a material inlet to the apparatus and a corresponding material outlet from the apparatus.

The apparatus by way of one embodiment includes a processing chamber through which the material to be processed passes. Within the chamber, a plurality of vertically stacked rotating shelves receive a layer of the material to be processed as the material cascades through the chamber from one shelf to another. The shelves are divided into multiple trays or segments fed by material supplied through one or more material inlets to the processing chamber. As the shelves rotate, material contained within each tray is discharged through an opening to one or more trays of an underlying shelf. In this manner, the material is processed within the trays as the material cascades within the chamber from shelf to shelf along separate material flow paths. As the material only moves a short distance on each shelf the material moves down through the apparatus faster and has a shorter retention time in the apparatus and on each shelf.

In accordance with one embodiment of the invention, there is disclosed an apparatus for processing material, the apparatus comprising a material processing chamber having at least one processing zone adapted for processing material, the chamber having at least two material inlet and at least two material outlets; a plurality of material supports arranged within the processing zones for receiving material cascading within the chamber, each of the supports including a plurality of trays each having at least one opening adapted to permit the passage of material from one tray to an underlying tray as the material cascades within the chamber. The material being processed cascades through the processing chamber along a plurality of separate material flow paths.

The material inlets supply material to be processed to a plurality of trays on an uppermost support within the chamber, and the material outlets discharge material from a lowermost support within the chamber.

The supports in the nature of trays, are arranged in a vertical stack within the chamber, whereby the openings in one tray are arranged directly over an underlying tray. The openings in one embodiment are elongated slots arranged radially extending thereby dividing the support into the plurality of trays or segments. The material cascades downwardly within the chamber in a spiral fashion along independent material flow paths.

In accordance with another embodiment of the invention there is disclosed an apparatus for processing material, the apparatus comprising a material processing chamber having a plurality of material inlets and at least one material outlet; a plurality of rotatable material supports arranged in a vertical stack within the chamber each having a plurality of spaced apart openings adapted to permit the passage of material from one support to an underlying support as the material cascades within the chamber, the openings dividing the support into a plurality of trays; a stationary leveler is optionally associated with each support for leveling material being processed on the support; and a stationary wiper for discharging material from one support through the opening onto an underlying support. The material being processed cascades through the processing chamber along a plurality of separate material flow paths.

The openings comprising elongated slots are arranged radially extending thereby dividing the tray into the plurality of tray segments. The openings can also be any shape arranged in the form of a mesh or grid. The material supports may be divided into unequal number of trays, the trays being the same or different size between the supports.

In accordance with another embodiment of the invention, there is disclosed an apparatus comprising a chamber having an interior in communication with a plurality of product inlets and a plurality of product outlets; and a plurality of shelves spaced in a vertical stack within the interior of the chamber between the product inlets and the product outlets, each of the shelves having a plurality of radially spaced apart openings adapted to permit material being processed to cascade from one shelf onto an underlying shelf as the material passes through the chamber from the product inlets to the product outlets, the openings dividing the shelves into a plurality of trays. The material being processed cascades through the processing chamber along a plurality of separate material flow paths.

In accordance with one embodiment of the invention, there is disclosed an apparatus for processing material, the apparatus comprising a material processing chamber having a plurality of processing zones therein adapted for processing material; a plurality of rotatable material supports arranged in a vertical stack within the chamber; the material supports each divided into a plurality of trays each adapted to receive material to be processed, each of the trays associated with an opening in the support for passage of material from one tray to another tray of an underlying support for processing the material as the material cascades between the support. The material being processed cascades through the processing chamber along a plurality of separate material flow paths.

In accordance with another embodiment of the invention, there is disclosed a method for processing material, the method comprising supplying material to be processed through a plurality of material inlets into a processing chamber; cascading the material through the chamber between a plurality of rotating material supports each having a plurality of openings for supplying material from one support to an underlying support; and discharging the processed material from a lowermost support from within the chamber. The material being processed cascades through the processing chamber along a plurality of separate material flow paths.

The material being processed can be heat sensitive material such as coffee beans in particulate form. The method further includes controlling the temperature within the chamber for processing the material therein, and maintaining a controlled environment within the chamber.

In accordance with another embodiment of the invention, there is described a method for processing material, the method comprising supplying material to be processed through a plurality of material inlets into a processing chamber; cascading the material from each of the inlets downwardly between a plurality of vertically stacked material supports each having a plurality of trays separated by an opening for supplying material from the trays of one support to the trays of an underlying support, whereby the material from each of the material inlets cascades along a separate path within the chamber; and discharging the material from the separate paths from within the chamber.

In accordance with another embodiment of the invention, there is described an apparatus for processing material, the apparatus comprising a material processing chamber having a plurality of material inlets and at least one material outlet; a plurality of rotatable material supports arranged in a vertical stack within the chamber each having a plurality of spaced apart openings adapted to permit the passage of material from one support to an underlying support as the material cascades within the chamber, the openings dividing the support into a plurality of trays; and a set of stationary wipers on each support equal to the number of material inlets so arranged that the material that enters each material inlet spirals down through the chamber so that all the material that enters the material inlet is repeatedly mixed and substantially all the material stays together so that the material moves down through the chamber in individual streams equal to the number of material inlets.

### BRIEF DESCRIPTION OF THE DRAWINGS

The subject matter regarded as the invention is particularly pointed out and distinctly claimed in the concluding portion of the specification. The invention, however, both as to organization and method of operation, together with features, objects and advantages thereof may best be understood by reference to the following detailed description when read with the accompanying drawings in which:

FIG. 1 is a perspective view of an apparatus in accordance with one embodiment for processing material supplied to stacked processing shelves having a plurality of trays;

FIG. 2 is a cross-sectional view of the apparatus as shown in FIG. 1; and

FIG. 3 is a perspective view of a processing shelf having multiple trays in accordance with one embodiment of the present invention.

### DETAILED DESCRIPTION

In describing the preferred embodiments of the invention illustrated in the drawings, specific terminology will be used for the sake of clarity. However, the invention is not intended to be limited to the specific terms so used, and it is to be understood that each specific term includes all equivalence that operate in a similar manner to accomplish a similar purpose.

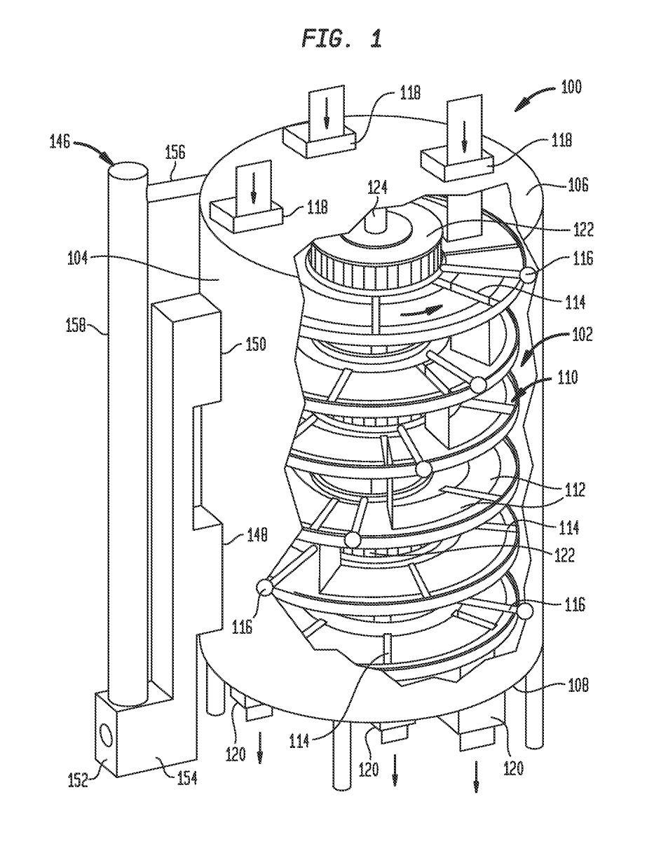

FIG. 1 shows an example of an apparatus 100 for processing material in accordance with one embodiment of the present invention. As shown, a hollow chamber 102 forms a central processing chamber which is cylindrical or polygonally enclosed by side wall 104 which extends around the circumference of the chamber, a top wall 106 and a bottom wall 108. The chamber 102 is provided with a plurality of adjacent processing zones extending generally continuously from the top wall 106 to the bottom wall 108 whereby material processing takes place simultaneously at a plurality of levels or zones.

The apparatus 100 may include a variety or types of components for transferring the material through the different zones. For example, the apparatus may incorporate a plurality of vertically stacked material supports such as shelves 110. According to one embodiment, the shelves 110 are divided into a plurality of trays or segments 112 by means of elongated radially spaced apart openings 114 within the shelves. In the preferred embodiment, the shelves 110 are formed as an annular shaped structure. The openings 114 allow material to pass from one tray to an underlying lower tray of an adjacent shelf 110 in a cascading fashion. For example, the shelves 110 may be attached to a rotating structure, and thus may rotate about a substantially vertical axis as the structure rotates. As a result, the material will cascade downwardly in a spiral fashion from shelf to shelf.

Cantilever devices or stationary wipers 116 are optionally arranged extending over the trays 110 to push material from the trays through the openings 114 as the shelves 110 rotate. Alternatively, the shelves may remain stationary, and the wipers 116 may sweep across the trays to discharge the material thereon. Accordingly, material is transferred from the top most shelf 110 within the chamber 102 through the plurality of vertically stacked shelves to the lower most shelf within the chamber for ultimate discharge from the apparatus 100. In accordance with the preferred embodiment, each shelf will be provided with a plurality of wipers 116 overlying the trays 112 therein.

The material to be processed is supplied to one or more material inlets 118 provided within the top wall 106. The inlets 118 are arranged overlying the top most shelf 112 for distributing the material onto each of the trays 112 of the shelf. Any number of inlets 118 may be provided for simultaneously feeding material into the apparatus 100 for processing. One or more material outlets 120 are provided on the bottom wall 108 for discharging material from the last most shelf in the apparatus 100. Accordingly, any number of material inlets 118 and any number of material outlets 120 may be provided for feeding the material to be processed into the chamber 102 and for discharging processed material therefrom. In the preferred embodiment, at least two material inlets and outlets are provided.

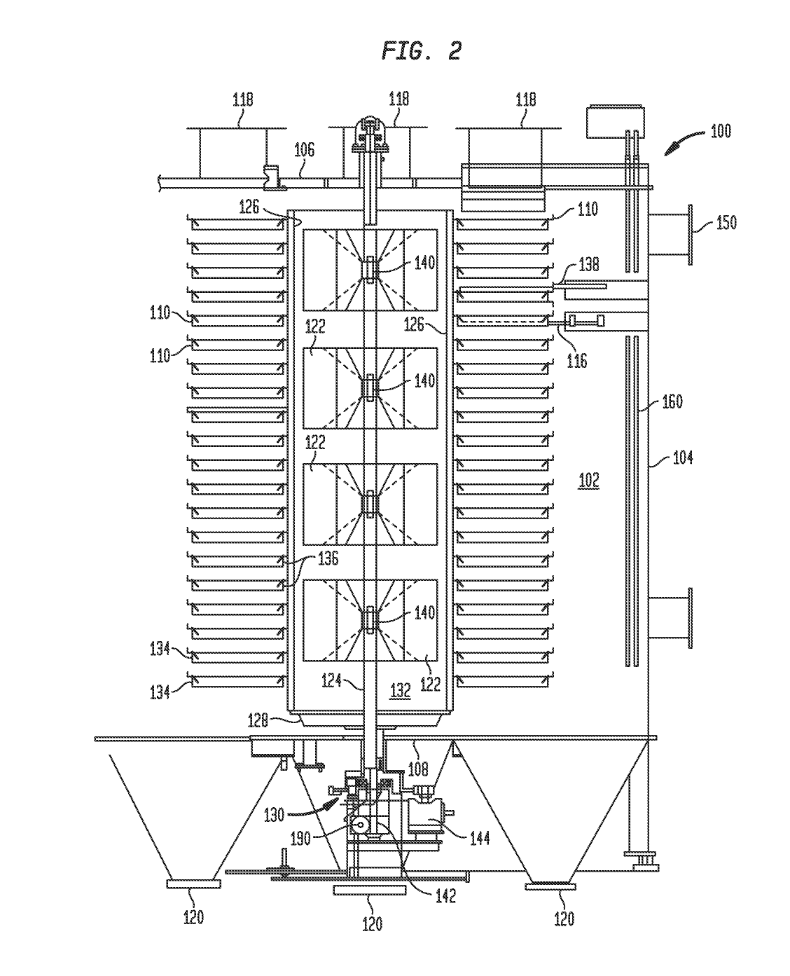

Referring to FIG. 2, there is illustrated in greater detail the construction of an apparatus 100 in accordance with one embodiment of the present invention. The apparatus 100 is suitable for use in a variety of applications for drying or other processing of materials, including the processes of torrefaction, pyrolytic extraction of hydrocarbons from oil shale, and the like. Inside the processing chamber 102, the apparatus 100 incorporates a plurality of annular shaped shelves 110 arranged one disposed over the other in a vertical stack. The shelves surround a plurality of vertically aligned fans 122 attached to a central fan shaft 124. The fans 122 circulate the atmosphere or environment inside the chamber over the material on the shelves. Each fan 122 typically covers several shelves, for example, often 6-8, thereby defining a processing zone with the apparatus.

The material to be processed is placed on the top most shelf 112 and progressively transferred to the lower most shelf in a cascading fashion. In the preferred embodiment, the material cascades along a spiral path. Each shelf is connected to at least one stanchion 126, wherein several stanchions are positioned around the fan shaft 124, thereby forming a squirrel cage. Coupled to the stanchions 126 is a turn table 128 at the lower end of the chamber 102. According to one embodiment, the turn table 128 is connected to the rotating cage structure which surrounds the fan shaft 124. At least one drive assembly 130 including a plurality of gears causes the turn table 128 to rotate, thereby causing the stanchions 126 and the shelves 112 to revolve.

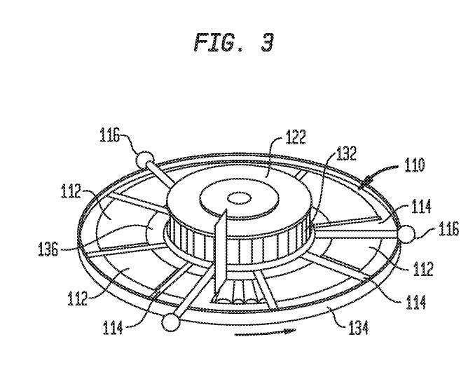

Referring to FIG. 3, there will be described in greater detail each of the shelves 110. The shelves 110 are generally planar in nature having an annular shape provided by a central opening 132. In the preferred embodiment, the shelves 110 are divided circumferentially into the plurality of trays 112 by the radially extending slot like openings 114. The openings 114 are sized to permit the material being processed on the tray to be discharged therefrom as to be described hereinafter.

It is contemplated that each shelf 110 can be divided into any number of trays. It is also not required that the size or length of each tray 112 in a shelf 110 be the same. For example, a shelf may have three trays, one extending 180° and two extending 90° each. In this embodiment, some of the material will be exposed to longer processing times. It is noted, however, that it is also not required that each shelf in the stack be divided into multiple trays, or that each shelf be divided into the same number of trays. Thus, it is contemplated that the shelves 110 may have different number of trays within the chamber 102. Further, the top shelves may be divided into less trays than the lower shelves in the treatment chamber 102. This will result in the material having a longer residence time in the top shelves and a shorter residence time in the lower shelves. As a result, the material flow rate from the top shelves to the bottom shelves increase or the opposite effect can be achieved by reversing the shelves arrangement. In addition, the openings 114 although individually being continuous, may be in segments or a plurality of smaller openings arranged in a pattern such as in a mesh or grid.

The outer and inner circumferential edges of the trays 112 are provided with a raised lip 134, 136 dimensioned in height so that each of the trays will contain a volume and layer thickness of material being processed. The specific height of each lip 134, 136 is generally dependent upon the particular material and the process being performed. Thus, in cases where thin layers of material are desired, the height of the lips 134, 136 will be relatively shallow. In the alternative, where thicker layers of material are to be processed, the height of the lips 134, 136 will be greater. Accordingly, the thickness of the material to be processed can be varied in the apparatus.

The tray wipers 116 are positioned circumferentially about each of the trays. The number and location of the wipers 116 determine the extent of travel of the material on the tray before it is discharged through one of the openings 114. For example, the inclusion of two wipers and two tray openings 114 arranged 180 degrees in separation will result in the material traveling somewhat less than 180 degrees in rotation before being discharged through one of the openings. Likewise, the provision of four wipers 116 and four openings 114 equally spaced in radial direction around a tray 110 will result in the material traveling somewhat less than 90 degrees of rotation before being discharged through one of the openings 114. The degree of material travel affects the residence time of the material on each tray, in addition to the rotational speed of the tray. Accordingly, the trays 110 may have any number of wipers 116.

A rigidly mounted leveler 138 is optionally provided within each shelf 110 to brush across the top surface of the material placed on the trays 112, thereby leveling the material and exposing material underneath the top portion to the environment within the chamber 102. Any number of levelers 138 may be positioned circumferentially around the shelves 110. Material that may be spilled by the shelf wipers 116 or levelers 138 over the sides of the shelves 110 fall onto an optionally provided catch plate (not shown). The catch plate, if provided, is angularly positioned with respect to the shelves to cause a material which is spilled off of a shelf above to fall onto the catch plate and be directed onto a shelf below. In this manner, the material being processed in the chamber 102 cascades downwardly from the upper shelf to a lower shelf.

As the material is being moved through the chamber 102 as thus far described, further elements may be implemented within the chamber to aide in processing. For example, several fans 140 may be included within the chamber to facilitate circulation of the environment such as heated and cold air, reactive and/or inert gases, as well as other environmental gases such as super heated steam. The fans 122 are effective to provide a more even temperature profile or environment within the chamber 102. The fans 122 may be connected to the fan shaft 124 by any suitable means such as keys 140. The fan shaft 124 extends through the bottom plate 108 of the apparatus 100 where it connects to the drive assembly 130, such as through a gear reducer 142 at its lower end. The fans 122 may be powered such as by motor 144, or by other power sources such as hydraulic, steam, gas or the like. As the reducer 142 causes the shaft 124 to rotate, the fans 122 rotate in turn, thus pushing the internal environment within the chamber 102 across the exposed material on each of the trays 112.

As previously described, the material being supplied to the apparatus 100 may undergo various processing conditions within the chamber 102. For example, the material may be subject to drying within the chamber 102, torrefaction, solvent recovery, chemical reaction, or drying or roasting or heat treating or calcining any other desired process. Typically, the processing of the material within the chamber 102 will be under a selected environment. By way of example, various environments may include heating, chilling, steam, inert gases, reactive gases such as oxygen, etc.

By way of one example, the apparatus 100 can be used in a method for roasting heat sensitive materials, such as coffee beans. In this regard, the apparatus 100 is provided with a manifold system 146 which includes multiple spaced apart hot air inlets 148, 150 in communication with the chamber 102, and an air inlet fan 152 in communication with a heater 154. Heated air within the chamber 102 may be recycled via air outlet 156 through conduit 158 back to the heater 154. It is also contemplated that internal heating rods or tubes 160 may also be incorporated into the chamber 102.

The apparatus 100 may be modified to include additional features, systems and equipment as dictated by the process being performed or other considerations. For example, if the apparatus 100 is used for solvent recovery, one or more condensers may be provided in communication with the interior of the chamber 102. Additionally, it is contemplated that certain processes may be performed at a negative pressure. Where the material being processed is subject to sublimation, the environment within the chamber 102 will pass through one or more condensers or other suitable devices for lowering the partial pressure of the substance contained within the material being processed. A supply of superheated steam may be provided particularly in cases where torrefaction is being performed, as well as systems for regenerating the superheated steam. These additional components of the apparatus 100 are illustrated in the applications which are incorporated herein by reference.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. (canceled)

2. A method for processing material in multiple streams through a processing chamber, the method comprising:
supplying material to be processed through a plurality of separate material inlets into a processing chamber;
cascading the material through the chamber between a plurality of rotating material supports each having a plurality of openings for supplying material from one support to an underlying support, wherein the material from each of the material inlets cascades along a separate spiral path within the chamber without commingling; and
discharging the processed material from a lowermost support from within the chamber.

3. The method of claims 2, further including using a plurality of wipers for discharging the material from each support through the openings therein to an underlying support.

4. The method of claim 2, further including controlling the temperature within the chamber for processing the material therein.

5. The method of claim 2, further including maintaining a controlled environment within the chamber.

6. The method of claim 2, further including leveling the material within each support using a leveler while rotating the supports.

7. The method of claim 2, wherein the plurality of material supports are spaced overlying one another in a vertical stack within an interior of the chamber, each of the supports having the plurality of openings radially spaced apart and adapted to permit material being processed to cascade from one support to an underlying support in individual streams along separate spiral flow paths without commingling as the material passes through the chamber, the plurality of openings dividing each of the supports into a plurality of trays corresponding to the number of material inlets, each of the trays on a support being associated with a corresponding one of the plurality of material inlets thereby preventing commingling of the material within the individual streams as the material cascades through the chamber in separate material spiral flow paths.

8. The method of claim 7, further including providing a wiper associated with each tray for discharging the material through one of the openings from one tray to an adjacent underlying tray associated with the same material inlet for cascading the material through the chamber, the number of wipers equal to the number of trays to provide spiral movement of the product as it cascades through the chamber.

9. A method for processing material in multiple streams through a processing chamber, the method comprising:
supplying material to be processed through a plurality of separate material inlets into a processing chamber;
cascading the material from each of the inlets downwardly between a plurality of vertically stacked material supports each having a plurality of trays separated by an opening for supplying material from the trays of one support to the trays of an underlying support, whereby the material from each of the material inlets cascades along a separate spiral path within the chamber; and
discharging the material from within the chamber.

10. The method of claim 9, further including using a plurality of wipers for discharging the material from each support through the openings therein to an underlying support.

11. The method of claim 10, wherein the wipers are maintained stationary and the supports are rotated.

12. The method of claim 10, wherein the wipers rotate and the supports remain stationary.

13. The method of claim 9, wherein the plurality of material supports are arranged overlying one another in the vertical stack within the chamber, the material supports each divided into the plurality of trays each adapted to receive material to be processed, each of the trays associated with the opening in the tray and one of the material inlets for passage of material from one tray to another tray of an underlying support for processing the material as the material cascades between the supports, wherein the number of trays within at least one material support is different from the number of trays within another material support within the chamber

14. The method of claim 13, further including discharging material from one tray through an associated opening onto an underlying tray using a wiper associated with each tray, whereby the residence time of the material cascading from tray to tray varies in accordance with the number of trays within an associated material support.

15. A method for processing individual streams of material along separate flow paths without commingling, the method comprising:
providing a material processing chamber having at least one processing zone adapted for processing material, the chamber having at least two separate material inlets and at least one material outlet;
arranging a plurality of material supports stacked within the chamber forming at least one processing zone for receiving material cascading through the chamber, each of the supports comprising a plurality of trays for receiving the material for processing, the number of trays in each support corresponding to the number of material inlets;
associating each of the plurality of trays with a corresponding one of the material inlets and having at least one opening associated therewith overlying an underling tray associated with the same material inlet thereby preventing commingling of the material as the material cascades through the chamber from tray to tray, the plurality of trays configured to permit the passage of material from one tray to an underlying tray in non-commingled individual streams as the material cascades through the chamber, each of the trays receiving material cascading through the chamber supplied only from an associated one of the material inlets, the material inlets and a corresponding opening within the trays forming separate spiral flow paths through the chamber for the material being processed in non-commingled individual streams, wherein each of said spiral flow paths correspond to one of the plurality of material inlets; and
associating a wiper with each tray for discharging material from one tray through the opening associated with the tray onto an underlying tray associated with the same material inlet to prevent commingling of the material.

16. The method of claim 15, further including rotating the trays while the wiper remains stationary for discharging material through the opening associated with the tray.

17. A method for processing material in multiple streams through a processing chamber, the method comprising:
feeding material to be processed through a plurality of separate material inlets into a processing chamber in individual material streams associated with one of the material inlets;
supplying the material from each material stream onto an associated tray of a support within the chamber, each tray having an opening for discharge of the material from the material stream onto a corresponding tray of an underling support;
cascading the material in individual material streams through the chamber between a plurality of vertically stacked supports each having a tray associated with one of the individual material streams; and
discharging the material processed within the chamber.

18. The method of claim 17, further including discharging the material from a tray through an associated opening using a wiper.

19. The method of claim 18, wherein the supports are rotated while the wiper is maintained stationary.

20. The method of claim 17, wherein the number of trays within a support corresponds to the number of material inlets.

21. The method of claim 17, wherein the individual material streams are not commingled as the material cascades within the chamber.
